(19) United States
(12) Patent Application Publication
(10) Pub. No.: US 2024/0267282 A1
(43) Pub. Date: Aug. 8, 2024

(54) INFORMATION PROCESSING APPARATUS, INFORMATION PROCESSING METHOD, COMPUTER READABLE MEDIUM, AND INFORMATION PROCESSING SYSTEM

(71) Applicant: NEC Corporation, Minato-ku, Tokyo (JP)

(72) Inventors: Jun NISHIOKA, Tokyo (JP); Yoshiaki SAKAE, Tokyo (JP); Hiroki TAGATO, Tokyo (JP); Takashi KONASHI, Tokyo (JP); Yuji KOBAYASHI, Tokyo (JP); Etsuko ICHIHARA, Tokyo (JP); Jun KODAMA, Tokyo (JP)

(73) Assignee: NEC Corporation, Minato-ku, Tokyo (JP)

(21) Appl. No.: 18/564,194

(22) PCT Filed: May 31, 2021
(86) PCT No.: PCT/JP2021/020607

§ 371 Date: Nov. 27, 2023

(51) Int. Cl. H04L 41/0659; H04L 9/40

(52) U.S. Cl. CPC H04L 41/0661; H04L 63/0227

(57) ABSTRACT

An information processing apparatus (10) includes acquisition means (11) for acquiring information indicating a defect of a first relay apparatus (20), and control means (12) for changing at least one of a setting of the first relay apparatus regarding communication and a setting of a second relay apparatus (20) regarding communication based on the information acquired by the acquisition means, the second relay apparatus being configured to communicate with the first relay apparatus.

### TECHNICAL FIELD

The present disclosure relates to an information processing apparatus, an information processing method, a non-transitory computer readable medium storing a program, and an information processing system.

### BACKGROUND ART

When a defect such as a bug (failure) or an information security vulnerability (security hole) is found in software (firmware) of a relay apparatus such as a router, it is known that the defect is corrected by updating the software of the relay apparatus.

Patent Literature 1 discloses that when a router receives a specific command that causes a failure, the failure is avoided by executing, instead of the specific command, another command registered in advance.

### CITATION LIST

### Patent Literature

Patent Literature 1: Japanese Unexamined Patent Application Publication No. 2012-124803

### SUMMARY OF INVENTION

### Technical Problem

However, there is a problem in the technology disclosed in Patent Literature 1 that, for example, it may not be possible to appropriately operate a communication network using a relay apparatus having a defect such as a bug or an information security vulnerability.

In view of the above-described problem, an object of the present disclosure is to provide an information processing apparatus, an information processing method, an information processing system, and a non-transitory computer readable medium storing a program that can appropriately operate a communication network using a relay apparatus having a defect.

### Solution to Problem

In a first example aspect according to the present disclosure, an information processing apparatus includes: acquisition means for acquiring information indicating a defect of a first relay apparatus; and control means for changing at least one of a setting of the first relay apparatus regarding communication and a setting of a second relay apparatus regarding communication based on the information acquired by the acquisition means, the second relay apparatus being configured to communicate with the first relay apparatus.

Further, a second example aspect according to the present disclosure provides an information processing method including: acquiring information indicating a defect of a first relay apparatus; and changing at least one of a setting of the first relay apparatus regarding communication and a setting of a second relay apparatus regarding communication based on the information acquired by the acquisition means, the second relay apparatus being configured to communicate with the first relay apparatus.

Further, a third example aspect according to the present disclosure provides a non-transitory computer readable medium storing a program for causing an information processing apparatus to: acquire information indicating a defect of a first relay apparatus; and change at least one of a setting of the first relay apparatus regarding communication and a setting of a second relay apparatus regarding communication based on the information acquired by the acquisition means, the second relay apparatus being configured to communicate with the first relay apparatus.

Further, a fourth example aspect according to the present disclosure provides an information processing system including an information processing apparatus, a first relay apparatus, and a second relay apparatus. In this information processing system, the information processing apparatus includes: acquisition means for acquiring information indicating a defect of a first relay apparatus; and control means for changing at least one of a setting of the first relay apparatus regarding communication and a setting of the second relay apparatus regarding communication based on the information acquired by the acquisition means, the second relay apparatus being configured to communicate with the first relay apparatus.

### Advantageous Effects of Invention

According to one example aspect, it is possible to appropriately operate a communication network using a relay apparatus having a defect.

### BRIEF DESCRIPTION OF DRAWINGS

FIG. 1 is a diagram showing an example of a configuration of an information processing apparatus according to an example embodiment;

FIG. 2 is a diagram showing an example of a configuration of an information processing system according to an example embodiment;

FIG. 3 is a diagram showing an example of a hardware configuration of the information processing apparatus according to an example embodiment;

FIG. 4 is a sequence diagram showing an example of processes performed by the information processing system according to an example embodiment;

FIG. 5 is a diagram showing an example of data recorded in a relay apparatus DB according to an example embodiment; and

FIG. 6 is a diagram showing an example of data recorded in a control content DB according to an example embodiment.

### EXAMPLE EMBODIMENT

The principle of the present disclosure will be described with reference to some illustrative example embodiments. It should be understood that these example embodiments are described for illustrative purposes only and will assist those skilled in the art in understanding and implementing the present disclosure without suggesting any limitations with regard to the scope of the present disclosure. The disclosure described herein may be implemented in a variety of ways other than those described below.

In the following description and claims, unless otherwise defined, the meanings of all technical and scientific terms used herein are the same as those generally understood by those skilled in the art to which the present disclosure pertains.

Example embodiments of the present disclosure will be described hereinafter with reference to the drawings.

### First Example Embodiment

### <Configuration>

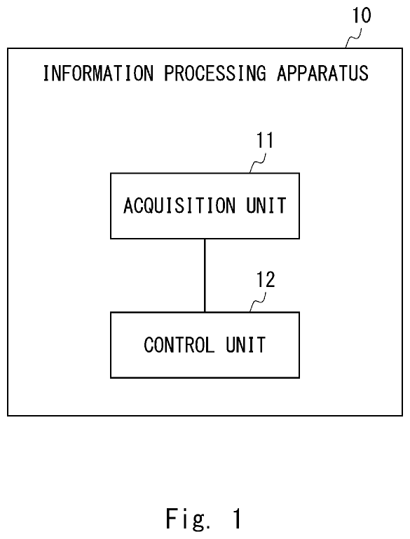

A configuration of an information processing apparatus 10 according to an example embodiment will be described with reference to FIG. 1. FIG. 1 is a diagram showing an example of the configuration of the information processing apparatus 10 according to the example embodiment. The information processing apparatus 10 includes an acquisition unit 11 and a control unit 12. These units may be implemented by one or more programs installed in the information processing apparatus 10 in cooperation with hardware such as a processor 101 and a memory 102 of the information processing apparatus 10.

The acquisition unit 11 acquires various types of information from an internal or external storage unit of the information processing apparatus 10 and an external apparatus. The acquisition unit 11, for example, acquires information indicating a defect such as a bug or information security vulnerability in a relay apparatus.

The control unit 12 performs various types of processes in the information processing apparatus 10. For example, the control unit 12 changes the setting of the relay apparatus regarding communication based on information acquired by the acquisition unit 11.

### Second Example Embodiment

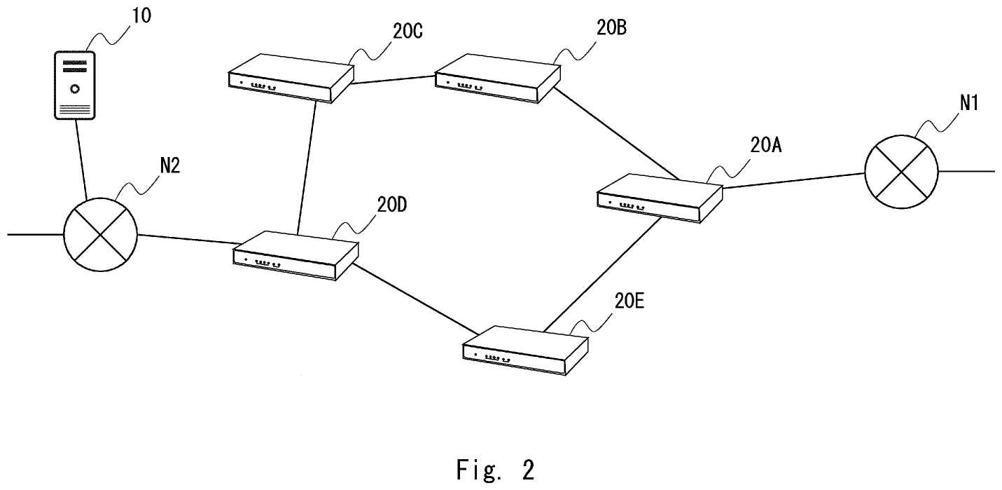

Next, a configuration of an information processing system 1 according to an example embodiment will be described with reference to FIG. 2.

### <System Configuration>

FIG. 2 is a diagram showing an example of the configuration of the information processing system 1 according to the example embodiment. In FIG. 2, the information processing system 1 includes the information processing apparatus 10. Further, the information processing system 1 includes a relay apparatus 20A, a relay apparatus 20B, a relay apparatus 20C, a relay apparatus 20D, and a relay apparatus 20E (hereinafter simply referred to as a “relay apparatus 20” when it is not necessary to distinguish them from each other). Note that the number of the information processing apparatuses 10 and the number of the relay apparatuses 20 are not limited to those in the example shown in FIG. 2.

The information processing apparatus 10 and the relay apparatus 20 are connected to each other so that they can communicate with each other through, for example, a Local Area Network (LAN) cable. In the example shown in FIG. 2, the relay apparatus 20A is connected to a network N1, the relay apparatus 20B, and the relay apparatus 20E. The relay apparatus 20C is connected to the relay apparatus 20B and the relay apparatus 20D. The relay apparatus 20D is connected to the relay apparatus 20E and a network N2. The network N1 may be, for example, an external network such as the Internet, a network outside a company, or a network of another company. In this case, the network N1 may be a core network of a local 5G.

The network N2 may be, for example, a network (an internal network) of a business operator that operates the relay apparatus 20. In this case, the network N2 may be a core network of a fifth-generation mobile communication system (5G). Note that one or more communication apparatuses may be connected to each of the relay apparatuses 20.

The information processing apparatus 10 manages an operation of the relay apparatus 20. For example, when the information processing apparatus 10 acquires information indicating that the relay apparatus 20 has a defect, it changes at least one of the setting of the relay apparatus 20 and the setting of another one of the relay apparatuses 20 so as to reduce the effect of the defect.

The relay apparatus 20 relays communication between the network N1 etc. and the network N2 etc. For example, the relay apparatus 20 may have a function such as a layer 3 switch including a router function and a layer 2 switch.

### <Hardware Configuration>

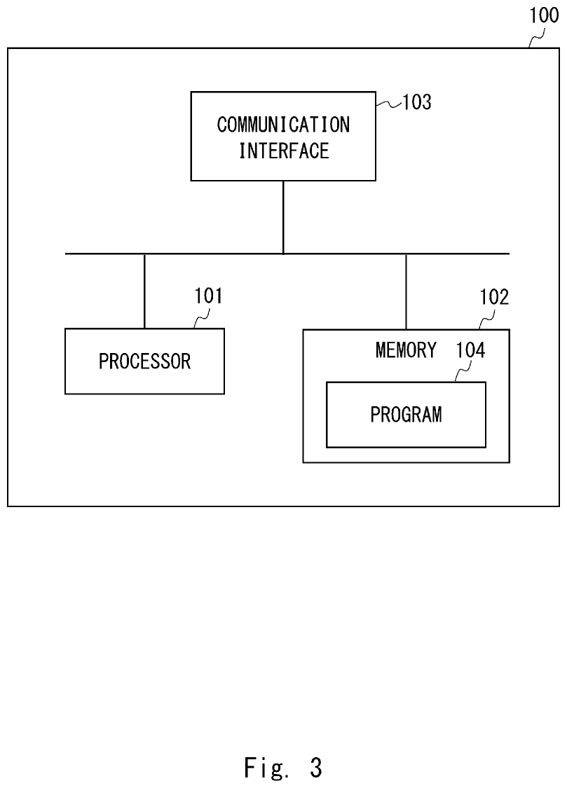

FIG. 3 is a diagram showing an example of a hardware configuration of the information processing apparatus 10 and the relay apparatus 20 according to the example embodiment. The information processing apparatus 10 will be described below as an example. Note that the hardware configuration of the relay apparatus 20 may be similar to that of the information processing apparatus 10 shown in FIG. 3.

In the example shown in FIG. 3, the information processing apparatus 10 (a computer 100) includes the processor 101, the memory 102, and a communication interface 103. These components may be connected to each other by a bus or the like. The memory 102 stores at least part of a program 104. The communication interface 103 includes interfaces required for communication with other network elements.

When the program 104 is executed by the processor 101 and the memory 102 in cooperation with each other, the computer 100 performs at least some of the processes according to the example embodiments of the present disclosure. The memory 102 may be of any type suitable for a local technical network. The memory 102 may, as a non-limiting example, be a non-transitory computer readable storage medium. Further, the memory 102 may be implemented using any suitable data storage technology, such as semiconductor-based memory devices, magnetic memory devices and systems, optical memory devices and systems, fixed and removable memories. Although the computer 100 including only one memory 102 is shown, the computer 100 may include some memory modules that are physically different from each other. The processor 101 may be of any type. The processor 101 may include one or more of a general-purpose computer, a dedicated computer, a microprocessor, a Digital Signal Processor (DSP), and, as a non-limiting example, a processor based on a multi-core processor architecture. The computer 100 may include a plurality of processors such as an application-specific integrated circuit chip that is temporally dependent on a clock that synchronizes the main processor.

The example embodiments of the present disclosure may be implemented in hardware or dedicated circuits, software, logic, or any combination thereof. Some aspects may be implemented in hardware, while other aspects may be implemented in firmware or software that may be executed by a controller, a microprocessor, or other computing devices.

The present disclosure also provides at least one computer program product that is tangibly stored in a non-transitory computer readable storage medium. The computer program product includes computer executable instructions, such as instructions included in program modules, and is executed on a device on a subject real or virtual processor to execute the processes or the method according to the present disclosure. The program modules include routines, programs, libraries, objects, classes, components, data structures, and the like that perform specific tasks or implement specific abstract data types. The functions of the program module may be combined or divided among the program modules as desired in various example embodiments. The machine executable instructions of the program module can be executed locally or within a distributed device. In the distributed device, the program modules can be located on both local and remote storage media.

Program codes for implementing the method according to the present disclosure may be written in any combination of one or more programming languages. These program codes may be provided to a processor or a controller of a general-purpose computer, a dedicated computer, or other programmable data processing apparatuses. When the program codes are executed by the processor or the controller, functions/operations in the flowcharts and/or functions/operations in the block diagrams to be implemented are executed. The program codes are executed entirely on the machine, partly on the machine, as a stand-alone software package, partly on the machine, partly on a remote machine, or entirely on a remote machine or a server.

The program can be stored and provided to a computer using any type of non-transitory computer readable media. Non-transitory computer readable media include any type of tangible storage media. Examples of non-transitory computer readable media include magnetic storage media, optical magnetic storage media, optical disk media, semiconductor memories, and the like. Magnetic storage media include, for example, flexible disks, magnetic tapes, hard disk drives, and the like. Optical magnetic storage media include, for example, magneto-optical disks and the like. Optical disk media include, for example, Blu-ray disks, Compact Disc (CD)-Read Only Memory (ROM), CD-Recordable (R), CD-ReWritable (RW), and the like. Semiconductor memories include, for example, mask ROM, PROM (Programmable ROM), EPROM (Erasable PROM), flash ROM, RAM (random access memory), and the like. The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### <Processing>

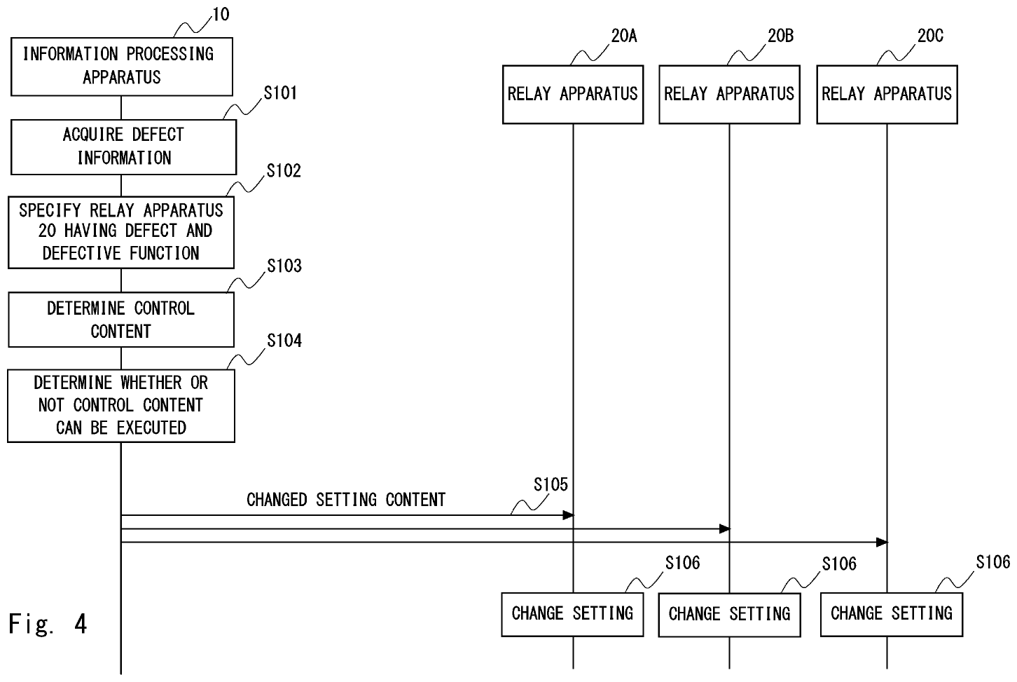

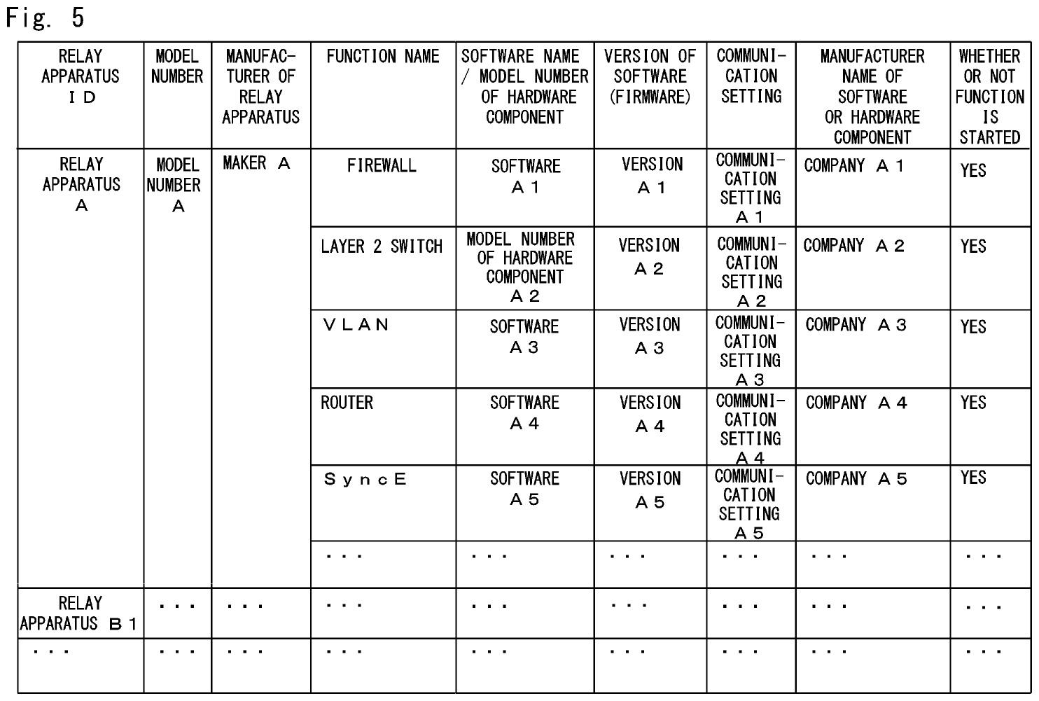

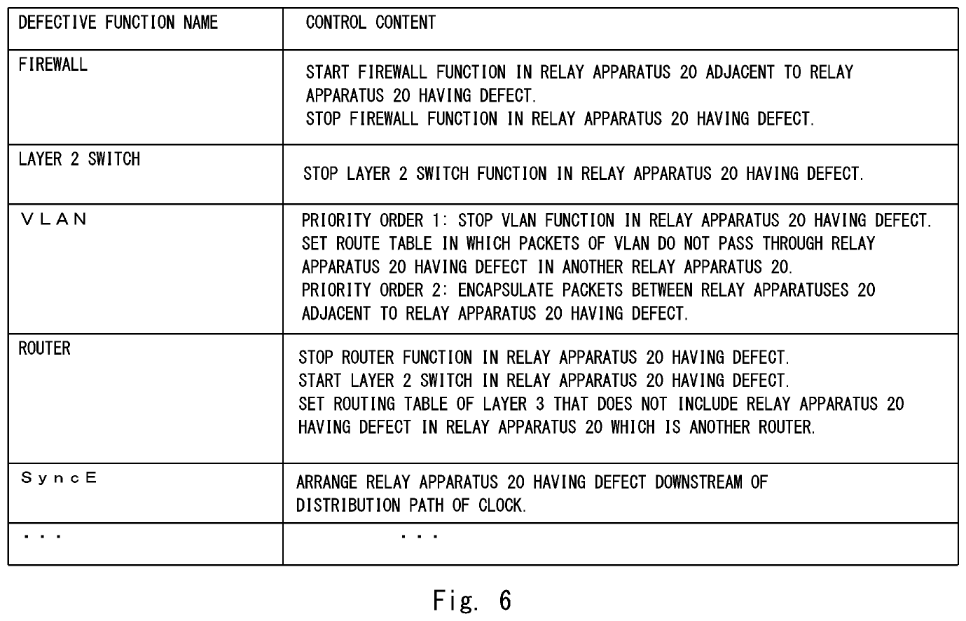

An example of processes performed by the information processing system 1 according to the example embodiment will be described with reference to FIGS. 4 to 6. FIG. 4 is a sequence diagram showing the example of processes performed by the information processing system 1 according to the example embodiment. FIG. 5 is a diagram showing an example of data recorded in a relay apparatus Data Base (DB) 501 according to the example embodiment. FIG. 6 is a diagram showing an example of data recorded in a control content DB 601 according to the example embodiment.

In Step S101, the acquisition unit 11 of the information processing apparatus 10 acquires defect information of the relay apparatus 20. The defect information is information indicating something having a defect. For example, the defect information may include information such as the model number (model) of the relay apparatus 20, the manufacturer (maker) of the relay apparatus, the function name (protocol name), the name of software or the model number of a hardware component, the version of software (firmware), and the manufacturer name of software or a hardware component of the relay apparatus 20, which relay apparatus, function, software, and software or hardware component have a defect.

Note that the information processing apparatus 10 may acquire defect information of the relay apparatus 20 from, for example, a predetermined Web site of the manufacturer of the relay apparatus 20. Further, the information processing apparatus 10 may acquire defect information of the relay apparatus 20 by, for example, mail sent from the manufacturer of the relay apparatus 20. In this case, the operator of the information processing apparatus 10 may register a mail address for receiving defect information at the manufacturer of the relay apparatus 20 in advance. Further, the information processing apparatus 10 may acquire defect information of the relay apparatus 20 from, for example, a vulnerability information sharing site operated by a predetermined organization.

The information processing apparatus 10 may acquire text data indicating the content of a defect in the relay apparatus 20 from the manufacturer of the relay apparatus 20 or the like. Further, the information processing apparatus 10 may acquire defect information by analyzing the morphemes of the acquired text and extracting predetermined keywords from the text data. Further, the information processing apparatus 10 may acquire defect information from the text data, for example, by Artificial Intelligence (AI) using deep learning.

Further, when the generation difference between the latest version of a specific software provided by the manufacturer of the relay apparatus 20 or the like and the version of the software currently used in the relay apparatus 20 is equal to or greater than a threshold, the information processing apparatus 10 may determine that the software has a defect.

Further, when a log output by a specific software of the relay apparatus 20 is acquired and a percentage of warnings, errors, and the like included in the acquired log is equal to or greater than a threshold, the information processing apparatus 10 may determine that the software has a defect.

Next, the control unit 12 of the information processing apparatus 10 refers to the relay apparatus DB 501 and specify the relay apparatus 20 having a defect and a defective function (Step S102). In the example shown in FIG. 5, the model number of the relay apparatus and information about the manufacturer of the relay apparatus are associated with the relay apparatus ID and recoded in the relay apparatus DB 501. The relay apparatus ID is identification information of the relay apparatus 20. The relay apparatus ID may be, for example, a communication address (e.g., an IP address, a MAC address) of the relay apparatus 20.

Further, the communication setting, the name of software or the model number of a hardware component, the version of software (firmware), the name of the manufacturer of software or a hardware component, and whether or not the function is started are associated with the relay apparatus ID and the function name and recorded in the relay apparatus DB 501. The name of software is the name of software that implements the function pertaining to the function name. The version of the software is the version of the software that implements the function pertaining to the function name. Whether or not the function is started is information indicating whether or not the function pertaining to the function name is started in the relay apparatus 20.

The communication setting is information of the setting regarding communication in the function pertaining to the function name. The communication setting of a router may include, for example, information of a routing table. The routing table may include, for example, information of a destination network, a next hop (forwarding destination), an output interface (output port), and the like.

The data recorded in the relay apparatus DB 501 may be registered in advance by an operation of an operator or the like of the information processing apparatus 10. Further, at least part of the data recorded in the relay apparatus DB 501 may be acquired from the relay apparatus 20 by the information processing apparatus 10 and recorded. Note that the relay apparatus DB 501 may be stored in a storage device inside the information processing apparatus 10 or stored in a storage device outside the information processing apparatus 10.

For example, the information processing apparatus 10 extracts, from the relay apparatuses 20 recorded in the relay apparatus DB 501, relay apparatuses 20 whose model number, function name or software name, and software version match those included in the defect information acquired in Step S101. Then, the information processing apparatus 10 may specifies that the function of the relay apparatus 20 for which it is “Yes” whether or not the function associated with the matched function name or software name is started is a relay apparatus 20 having the defect.

Next, the control unit 12 of the information processing apparatus 10 refers to the control content DB 601 based on the defect information, and determines control contents of the settings of one or more relay apparatuses 20 so that use of a defective function in the relay apparatus 20 having a defect is reduced (Step S103). In the example shown in FIG. 6, the control content is associated with the function name and registered in the control content DB 601. Note that the data recorded in the control content DB 601 may be registered in advance by an operation of an operator or the like of the information processing apparatus 10. Note that the control content DB 601 may be stored in a storage device inside the information processing apparatus 10 or stored in a storage device outside the information processing apparatus 10.

The control contents may include, for example, starting the defective function in another relay apparatus 20 (e.g., an adjacent relay apparatus 20), restricting (degenerating, stopping) at least part of the defective function, and the like. The control contents may also include, for example, making another relay apparatus 20 encapsulate a packet using the defective function, changing a communication route using the defective function, and the like.

(Example in which a Function is Started in Another Relay Apparatus 20)

When a firewall function of the first relay apparatus 20 is defective, the information processing apparatus 10 may start a firewall function of the second relay apparatus 20 different from the first relay apparatus 20. By doing so, for example, the firewall function can be executed by the second relay apparatus 20 instead of the first relay apparatus 20 having a defect or in addition to the first relay apparatus 20 having a defect.

In the example shown in FIG. 6, it is specified that when a firewall function of a certain relay apparatus 20 is defective, a firewall function of a relay apparatus 20 adjacent to the relay apparatus 20 having a defect be started and the firewall function of the relay apparatus 20 having a defect be stopped. It is also specified that when a layer 2 switch function of a certain relay apparatus 20 is defective, this function of the certain relay apparatus 20 be stopped. In this case, in the example shown in FIG. 2, for example, when the firewall function of the relay apparatus 20A is defective, the firewall functions of the relay apparatus 20B and the relay apparatus 20D that are adjacent to the relay apparatus 20A are started, and the firewall function of the relay apparatus 20A is stopped.

(Example in which at Least Part of the Function is Restricted (Degenerated, Stopped))

When a layer 3 switch function of a certain relay apparatus 20 is defective, the information processing apparatus 10 may stop the layer 3 switch function of the certain relay apparatus 20 and execute a layer 2 switch function of the certain relay apparatus 20. By doing so, for example, the effect of stopping the defective function on the network can be reduced.

In the example shown in FIG. 6, it is specified that when a router function of a certain relay apparatus 20 is defective, the router function of the certain relay apparatus 20 be stopped and a layer 2 switch be started (degeneration from the layer 3 switch to the layer 2 switch). It is also specified that a routing table of the layer 3 that does not include the relay apparatus 20 having a defect be set in a relay apparatus 20 which is another router.

(Example in which a Communication Route Using the Function is Changed)

When a relay function of a packet of a specific protocol in a certain relay apparatus 20 is defective, the information processing apparatus 10 may change the setting of another relay apparatus 20 so that the packet of the specific protocol is transmitted through a route that does not involve the certain relay apparatus 20. By doing so, for example, the use of the function in the relay apparatus 20 having a defect can be reduced.

In the example shown in FIG. 6, it is specified that when a VLAN function of a certain relay apparatus 20 is defective, this function of the relay apparatus 20 having a defect be stopped as a priority order 1, and a route table in which packets of the VLAN do not pass through the relay apparatus 20 having a defect be set in another relay apparatus 20. In this case, in the example shown in FIG. 2, for example, when a VLAN function of the relay apparatus 20B is defective, the VLAN function of the relay apparatus 20B is stopped. Further, routing tables in the relay apparatus 20A, the relay apparatus 20D, and the like are changed so that the VLAN packets are not forwarded to the relay apparatus 20B.

Further, it is specified that when a Synchronous Ethernet (SyncE) function of a certain relay apparatus 20 is defective, the route be changed so that the certain relay apparatus 20 is located downstream of the distribution path of a clock.

(Example in which a Packet Using the Function is Made to be Encapsulated by Another Relay Apparatus 20)

When a relay function of a packet of a specific protocol in a certain relay apparatus 20 is defective, the information processing apparatus 10 may change the setting of another relay apparatus 20 so that the packet of the specific protocol is encapsulated and then transmitted to the certain relay apparatus 20. By doing so, for example, the use of the function in the relay apparatus 20 having a defect can be reduced.

In the example shown in FIG. 6, it is specified that when a VLAN function of a certain relay apparatus 20 is defective and it is not possible to stop this function of the certain relay apparatus 20, packets of the VLAN be encapsulated between adjacent relay apparatuses 20 as a priority order 2. Note that, in a case where packets of the VLAN are encapsulated between adjacent relay apparatuses 20, in the example shown in FIG. 2, for example, when a VLAN function of the relay apparatus 20B is defective, packets of the VLAN are encapsulated between the relay apparatus 20A and the relay apparatus 20C that are adjacent to the relay apparatus 20B. Note that encapsulating means, for example, that an entire packet is embedded in a payload of a communication protocol different from that of the packet and communication is performed.

Next, the control unit 12 of the information processing apparatus 10 determines whether or not the determined control content can be executed (Step S104). Note that when, for example, a firewall function or a gateway (protocol converter) function is started in the relay apparatus 20 having a defect, the information processing apparatus 10 may determine that it is not possible to stop a router function.

Further, when, for example, stopping of a certain function of the relay apparatus 20 having a defect prevents the network from maintaining its function, the information processing apparatus 10 may determine that it is not possible to stop the certain function. In this case, when, for example, stopping of a function of forwarding a packet of a predetermined protocol (e.g., a VLAN function) eliminates a route that does not involve the relay apparatus 20, it may be determined that the network is prevented from maintaining its function.

Further, when, for example, the adjacent relay apparatus 20 does not have a specific function (e.g., a firewall function, a VLAN function, etc.), the information processing apparatus 10 may determine that it is not possible to start the function in the adjacent relay apparatus 20.

When the information processing apparatus 10 determines that the determined control content cannot be executed, the information processing apparatus 10 may transmit a notification indicating that the determined control content cannot be executed to a terminal of an administrator of the information processing system 1. Note that the information processing apparatus 10 may include, for example, defect information acquired in Step S101 and information indicating the control content determined in Step S103 in the notification.

When the information processing apparatus 10 determines that the determined control content can be executed, the processes described below are executed. Note that the information processing apparatus 10 may transmit a notification indicating that the determined control contents can be executed to a terminal of an administrator of the information processing system 1. Note that the information processing apparatus 10 may include, for example, defect information acquired in Step S101 and information indicating the control content determined in Step S103 in the notification. Further, the information processing apparatus 10 may not execute the processes described below unless an approval operation is performed by the administrator of the information processing system 1. On the other hand, when an approval operation is performed, the information processing apparatus 10 may execute the processes described below.

Next, the control unit 12 of the information processing apparatus 10 transmits a command for changing the setting content in accordance with the determined control content to at least one of the relay apparatus 20 having a defect and another one of the relay apparatuses 20 (Step S105). Note that the command may include, for example, data of the communication setting of the changed route table or the like.

Next, the relay apparatus 20 that has received the command changes the communication setting according to the received command (Step S106). Thus, for example, when a defect such as a bug or information security vulnerability is found in software of the relay apparatus 20, the effect of the defect can be reduced even before the software is updated. Therefore, it is possible to appropriately operate a communication network.

Note that when defective software is updated in a certain relay apparatus 20, the information processing apparatus 10 may restore the settings of one or more relay apparatuses 20 regarding communication, the setting contents of the one or more relay apparatuses 20 having been changed in the process of Step S105. By doing so, for example, when the defect is corrected, the previous settings can be restored. In this case, when the information processing apparatus 10 changes the setting contents in the process of Step S105, the original settings of the relay apparatuses 20 regarding communication may be recorded as a history. Further, for example, when a predetermined operation is executed by an administrator of the relay apparatus 20, the relay apparatus 20 may download software in which a defect is corrected from a Web site of a manufacturer of the relay apparatus 20 or the like and install it. Further, when a predetermined operation is performed by an operator or a predetermined notification is received from the relay apparatus 20, the information processing apparatus 10 may restore the settings of the relay apparatuses 20 regarding communication based on the recorded history.

### Modified Example

The information processing apparatus 10 may be implemented by, for example, cloud computing composed of one or more computers. Further, the information processing apparatus 10 and the relay apparatus 20 may be configured as an integrated server (apparatus). The information processing apparatus 10 as described above is also included in an example of the “information processing apparatus” according to the present disclosure.

Note that the present disclosure is not limited to the above-described example embodiments and may be changed as appropriate without departing from the scope and spirit of the present disclosure.

The whole or part of the example embodiments disclosed above can be described as, but not limited to, the following supplementary notes.

### (Supplementary Note 1)

An information processing apparatus comprising:
acquisition means for acquiring information indicating a defect of a first relay apparatus; and
control means for changing at least one of a setting of the first relay apparatus regarding communication and a setting of a second relay apparatus regarding communication based on the information acquired by the acquisition means, the second relay apparatus being configured to communicate with the first relay apparatus.

### (Supplementary Note 2)

The information processing apparatus according to supplementary note 1, wherein the control means determines at least one of the setting of the first relay apparatus regarding communication and the setting of the second relay apparatus regarding communication so that use of a defective function of the first relay apparatus is reduced.

### (Supplementary Note 3)

The information processing apparatus according to supplementary note 1 or 2, wherein the control means restores at least one of the setting of the first relay apparatus regarding communication and the setting of the second relay apparatus regarding communication when software having a defect is updated in the first relay apparatus.

### (Supplementary Note 4)

The information processing apparatus according to any one of supplementary notes 1 to 3, wherein the control means specifies the defective function of the first relay apparatus from a text indicating a content of the defect of the first relay apparatus.

### (Supplementary Note 5)

The information processing apparatus according to any one of supplementary notes 1 to 4, wherein the control means starts a firewall function of the second relay apparatus when a firewall function of the first relay apparatus is defective.

### (Supplementary Note 6)

The information processing apparatus according to any one of supplementary notes 1 to 5, wherein the control means stops a router function of the first relay apparatus and executes a layer 2 switch function of the first relay apparatus when the router function of the first relay apparatus is defective.

### (Supplementary Note 7)

The information processing apparatus according to any one of supplementary notes 1 to 6, wherein when a relay function of a packet of a specific protocol in the first relay apparatus is defective, the control means changes the setting of the second relay apparatus so that the packet of the specific protocol is encapsulated and then transmitted to the first relay apparatus.

### (Supplementary Note 8)

The information processing apparatus according to any one of supplementary notes 1 to 7, wherein when a relay function of a packet of a specific protocol in the first relay apparatus is defective, the control means changes the setting of the second relay apparatus so that the packet of the specific protocol is transmitted through a route that does not involve the first relay apparatus.

### (Supplementary Note 9)

An information processing method comprising:
acquiring information indicating a defect of a first relay apparatus; and
changing at least one of a setting of the first relay apparatus regarding communication and a setting of a second relay apparatus regarding communication based on the acquired information, the second relay apparatus being configured to communicate with the first relay apparatus.

### (Supplementary Note 10)

A non-transitory computer readable medium storing a program for causing an information processing apparatus to:
acquire information indicating a defect of a first relay apparatus; and
change at least one of a setting of the first relay apparatus regarding communication and a setting of a second relay apparatus regarding communication based on the acquired information, the second relay apparatus being configured to communicate with the first relay apparatus.

### (Supplementary Note 11)

An information processing system comprising an information processing apparatus, a first relay apparatus, and a second relay apparatus, the information processing apparatus comprising:
acquisition means for acquiring information indicating a defect of a first relay apparatus; and
control means for changing at least one of a setting of the first relay apparatus regarding communication and a setting of the second relay apparatus regarding communication based on the information acquired by the acquisition means, the second relay apparatus being configured to communicate with the first relay apparatus.

### (Supplementary Note 12)

The information processing system according to supplementary note 11, wherein the control means determines at least one of the setting of the first relay apparatus regarding communication and the setting of the second relay apparatus regarding communication so that use of a defective function of the first relay apparatus is reduced.

### REFERENCE SIGNS LIST

1 INFORMATION PROCESSING SYSTEM
10 INFORMATION PROCESSING APPARATUS
11 ACQUISITION UNIT
12 CONTROL UNIT
20 RELAY APPARATUS

What is claimed is:

1. An information processing apparatus that controls relay apparatus, comprising:
at least one memory storing instructions, and
at least one processor configured to execute the instructions to;
acquire information indicating a defect of a first relay apparatus; and
change at least one of a setting of the first relay apparatus regarding communication and a setting of a second relay apparatus regarding communication based on the acquired information, the second relay apparatus being configured to communicate with the first relay apparatus.

2. The information processing apparatus according to claim 1, wherein the at least one processor is configured to determine at least one of the setting of the first relay apparatus regarding communication and the setting of the second relay apparatus regarding communication so that use of a defective function of the first relay apparatus is reduced.

3. The information processing apparatus according to claim 1, wherein the at least one processor is configured to restore at least one of the setting of the first relay apparatus regarding communication and the setting of the second relay apparatus regarding communication when software having a defect is updated in the first relay apparatus.

4. The information processing apparatus according to claim 1, wherein the at least one processor is configured to specify the defective function of the first relay apparatus from a text indicating a content of the defect of the first relay apparatus.

5. The information processing apparatus according to claim 1, wherein the at least one processor is configured to start a firewall function of the second relay apparatus when a firewall function of the first relay apparatus is defective.

6. The information processing apparatus according to claim 1, wherein the at least one processor is configured to stop a router function of the first relay apparatus and executes a layer 2 switch function of the first relay apparatus when the router function of the first relay apparatus is defective.

7. The information processing apparatus according to claim 1, wherein when a relay function of a packet of a specific protocol in the first relay apparatus is defective, the at least one processor is configured to change the setting of the second relay apparatus so that the packet of the specific protocol is encapsulated and then transmitted to the first relay apparatus.

8. The information processing apparatus according to claim 1, wherein when a relay function of a packet of a specific protocol in the first relay apparatus is defective, the at least one processor is configured to change the setting of the second relay apparatus so that the packet of the specific protocol is transmitted through a route that does not involve the first relay apparatus.

9. An information processing method that controls relay apparatus comprising:
acquiring information indicating a defect of a first relay apparatus; and
changing at least one of a setting of the first relay apparatus regarding communication and a setting of a second relay apparatus regarding communication based on the acquired information, the second relay apparatus being configured to communicate with the first relay apparatus.

10. A non-transitory computer readable medium storing a program for causing an information processing apparatus that controls relay apparatus to:
acquire information indicating a defect of a first relay apparatus; and
change at least one of a setting of the first relay apparatus regarding communication and a setting of a second relay apparatus regarding communication based on the acquired information, the second relay apparatus being configured to communicate with the first relay apparatus.

11. An information processing system comprising an information processing apparatus that controls relay apparatus, a first relay apparatus, and a second relay apparatus, the information processing apparatus comprising:
at least one memory storing instructions, and
at least one processor configured to execute the instructions to;
acquire information indicating a defect of a first relay apparatus; and
change at least one of a setting of the first relay apparatus regarding communication and a setting of the second relay apparatus regarding communication based on acquired information, the second relay apparatus being configured to communicate with the first relay apparatus.

12. The information processing system according to claim 11, wherein the at least one processor is configured to determine at least one of the setting of the first relay apparatus regarding communication and the setting of the second relay apparatus regarding communication so that use of a defective function of the first relay apparatus is reduced.
